(19) United States
(12) Patent Application Publication
(10) Pub. No.: US 2017/0316358 A1
(43) Pub. Date: Nov. 2, 2017

(54) Collaborative Network-Based Graphical Progress Management Platform for Creating Private and Public Template Flows

(71) Applicant: Progressly, Inc., Redwood City, CA (US)

(72) Inventors: Nick Candito, Redwood City, CA (US); Clarence Wooten, Palo Alto, CA (US); Eren Emre Kanal, San Francisco, CA (US)

(73) Assignee: Progressly, Inc., Redwood City, CA (US)

(21) Appl. No.: 15/143,116

(22) Filed: Apr. 29, 2016

(51) Int. Cl. G06Q 10/06; G06F 3/0485; G06F 3/0484

(52) U.S. Cl. CPC G06Q 10/0639; G06F 3/04842; G06F 3/04855

(57) ABSTRACT

In one embodiment, a progress management system (e.g., collaborative network-based graphical progress management platform) includes features for creating private and public template flows for business processes. For example, a computer implemented method includes obtaining, with the progress management system, identification information to identify a user with respect to the progress management system as implemented in an organization of the user and creating, with the progress management system, a template flow architecture that includes a private template flow having a combination of rows, operations, and rich content including instructional data. The method also includes enabling metadata of the private template flow for members or users of the organization and creating, with the progress management system, a new record of a public template flow based on the private template flow.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

At least one embodiment of the present invention pertains to a network-based, collaborative, graphical progress management platform having features for creating private and public template flows for business processes.

### BACKGROUND

In today's busy work environment, a person can become overwhelmed by having to attend numerous meetings, keep track of many projects at the same time, and utilizing numerous software tools and accounts for collaborative work projects. As demands upon a person's time increase, personal efficiency tends to decrease. A user may have access to numerous software tools but not be able to effectively use the features of the tools in an efficient manner.

### SUMMARY

In one embodiment, a progress management system (e.g., collaborative network-based graphical progress management platform) includes features for creating private and public template flows for business processes. For example, a computer implemented method includes obtaining, with the progress management system, identification information to identify a user with respect to the progress management system as implemented in an organization of the user and creating, with the progress management system, a template flow architecture that includes a private template flow having a combination of rows, operations, and rich content including instructional data. The method also includes enabling metadata of the private template flow for members or users of the organization and creating, with the progress management system, a new record of a public template flow based on the private template flow.

The method also includes disabling, with the progress management system, metadata of the public template flow and hosting the public template flow on a public website. In one example, the method includes receiving, with the public website, a user selection from a visitor for adopting the public template flow, loading, with a public flow module of the progress management system, data of the public flow template, and cloning database records of the public flow template for a new organization of the visitor.

### BRIEF DESCRIPTION OF THE DRAWINGS

One or more embodiments of the present invention are illustrated by way of example and not limitation in the figures of the accompanying drawings, in which like references indicate similar elements.

FIG. 1 is a block diagram of exemplary system architecture for providing a progress management system in accordance with one embodiment.

FIG. 2 is a block diagram of a system 250 in which a device 230 having a progress management application 252 is in communication with a progress management server 260 in accordance with one embodiment.

FIG. 3 illustrates a flow diagram of operations for a progress management system for providing private and public templates for business processes in accordance with one embodiment.

FIG. 4 illustrates a block diagram of a flow architecture of a progress management system for providing private and public templates for business processes in accordance with one embodiment.

FIG. 5 illustrates an example of a flow template presented by the progress management system in accordance with one embodiment.

FIG. 6 shows an example, at a high level, of the internal architecture of a processing system 1600 representing any of the devices mentioned above, e.g., the PM server or any of the client devices in one embodiment.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, such references are not necessarily mutually exclusive either.

Introduced herein is a network-based, collaborative, graphical progress management platform having features for creating private and public template flows for business processes. The platform combines project management, process management and client communication into (in some embodiments) a cloud-based software application, that makes it easy for professionals to turn any project or process into a visual workflow, called a “process,” that communicates progress and keeps team members and stakeholders informed, aligned and on-task. A process is a visual process flow (i.e. a visual representation of a multi-step process) that provides an indication of progress made in performance of the process. Processes make progress visual and transparent, freeing up professionals from having to explain progress on various projects, so that they can spend more time making progress. The technique and apparatus introduced here are collectively called “the tool” or “the platform” to facilitate description. The tool accomplishes this by enabling users to create private and public flow templates for graphically and collaboratively creating, editing, sharing and commenting on process.

Processes are built by using a unique graphical user interface (GUI), provided by the tool that communicates progress and process via a visual collaborative timeline. A process visually represents progress made in that process, in a single visual representation. It includes a “timeline-based” to-do list (e.g., step boxes) with built in “how-to” instructions and other resources. When “how-to” instructions are included within the steps of a process, the process doubles as a step-by-step process roadmap that can be cloned and even published for purchase by users seeking to execute an existing best-practice workflow.

When progress is made, the collaborator updates a step box of a process to show progress by inserting assets (e.g., by dragging and dropping) such as images, documents, videos or web links from sources such as the collaborator's desktop, mobile device, uniform resource locator (URL), cloud storage providers or other web services. The resulting progress transforms the step box into a visual representation that displays and archives what progress was made, when it was made, who made it, and where the assets are. A process can also be embedded in other Web based content, such as blog posts, web pages and other applications that support HTML.

The tool can be implemented by using a conventional client-server model, which can support desktop clients as well as mobile clients. The server side may be implemented by, for example, one or more server-class computers and data storage devices. The client devices may include, for example, desktop computers, laptop or notebook computers, tablet devices, smartphones, and other types of devices.

Conventional hardware can be used on both the server side and the client side to support software that provides the functionality introduced herein. For example, in one embodiment, the client only needs conventional hardware and a conventional software-implemented web browser to access the tool functionality, which is mostly implemented by software and data on the server side.

The progress management tool can be used in combination with or include a relationship management that involves the capture, analysis, and reporting of communications between a single user, or multiple users, within an organization, and various contacts outside of the organization. When a user engages in communication, in concert with a group of users, from an organization, those users are said to be collaborators. Furthermore, when the user and/or collaborators engage in communication with contacts outside the organization for a specific purpose (e.g., sales, business, recruiting, funding, etc.), a relationship is formed. These communications, between relationships and collaborators, may be part of a series of sequential communication and action stages of a process, such as stages of a sales process (e.g., first contact, product demo, price quote, offer, close), a business development process (e.g., growth identification, partner identification, project assignment, growth tracking), a recruiting process (e.g., candidate contact, resume obtained, initial interview, follow-up interview, offer or decline), as well as other processes which are, or can, be carried out with electronic communications. These communications, once identified as belonging to one or more processes, may then be viewed by users and collaborators involved in the particular process. Furthermore, reports may be generated which summarize, provide different visualizations, show progression within a process, and provide feedback on the progression within a process.

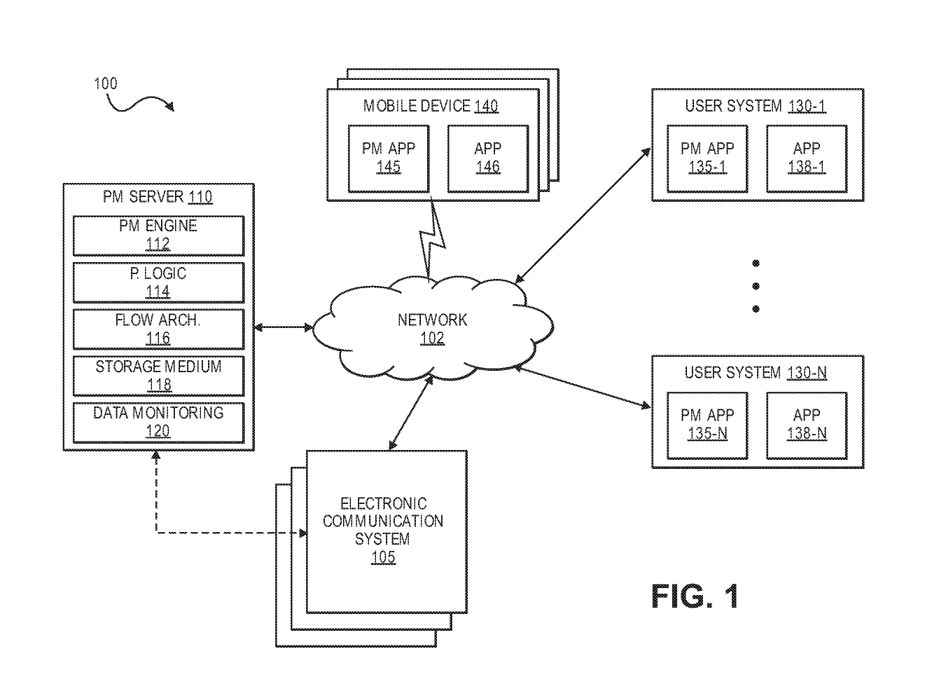

FIG. 1 is a block diagram of exemplary system architecture for providing a progress management system in accordance with one embodiment. In one embodiment, the system 100 includes a plurality of user systems, such as user system 130-1 to user system 130-N, mobile devices 140, progress management server 110, and a plurality of electronic communication systems 105. In one embodiment, user systems 130-1 to 130-N may each be a personal computing device, such as a desktop computer, laptop computer, tablet computer, etc. In one embodiment, each mobile device 140 may be a mobile computing device, such as a mobile telephone, personal digital assistant, tablet, etc. The progress management server 110 and electronic communication system 105 may also be computing devices, such as server computers, desktop computers, etc.

The user systems 130-1 through 130-N, mobile devices 140, progress management server 110, and electronic communication system 105 may be coupled to a network 102 and communicate with one another using any of the standard protocols for the exchange of information. In one embodiment, mobile device 140 is coupled with network 102 via a wireless connection, such as a cellular telephone connection, wireless fidelity connection, etc.

In one embodiment, one or more of the user systems 130-1 through user system 130-N, mobile device 140, progress management server 110, and the plurality of electronic communication systems 105 may run on one Local Area Network (LAN) and may be incorporated into the same physical or logical system, or different physical or logical systems. Alternatively, the user systems 130-1 through user system 130-N, mobile device 140, progress management server 110, and the plurality of electronic communication systems 105 may reside on different LANs, wide area networks, cellular telephone networks, etc. that may be coupled together via the Internet but separated by firewalls, routers, and/or other network devices. In yet another configuration, the progress management server 110 and one or more of the electronic communication systems 105 may reside on the same server, or different servers, coupled to other devices via a public network (e.g., the Internet) or a private network (e.g., LAN). It should be noted that various other network configurations can be used including, for example, hosted configurations, distributed configurations, centralized configurations, etc.

In one embodiment, the applications (e.g., 138-1 to 138-N, progress management applications 135-1 through progress management applications 135-N) may be applications presented to a user via a web interface, stand-alone applications installed on user systems 130-1 through 130-N, or a combination of application types. Furthermore, applications (e.g., PM application 145, 146) may be a mobile application. In one embodiment, any of these applications are user applications that enable a user to register with progress management server 110 for the automatic and intelligent creation of a progress management system even if these applications do not relate to progress management. For example, a collaborative software application 146 or 138 may be used for registering with the progress management server 110.

In one embodiment, a progress management application or other type of application, associated with a single user, transmits a registration request and registration data to progress management server 110. The registration data may include a username and password that enables the user to access the progress management server 110. In one embodiment, the registration data may further include usernames and authentication credentials that enable the user to access one or more electronic communication systems 105.

Progress management server 110 receives the registration data and creates a progress management account for the user, and associates the received usernames and authentication credentials with the newly provisioned progress management account. In one embodiment, progress management server 110 automatically obtains past electronic communications to and from the user by utilizing the received usernames and access credentials to access the specified electronic communication systems 105. For example, progress management server 110 may access collaborative software tools, email systems, social networking systems, VOIP systems, teleconferencing systems, etc. Once authenticated into an electronic communication system 105, progress management server 110 accesses the user's past electronic communications.

The PM server 110 includes a PM engine for PM decisions, processing logic 114 (e.g., at least one processor 114), a flow architecture 116 for creating private and public template flows, a storage medium for storing instructions and software programs, and a data monitoring module 120 for monitoring resources for users of third party services.

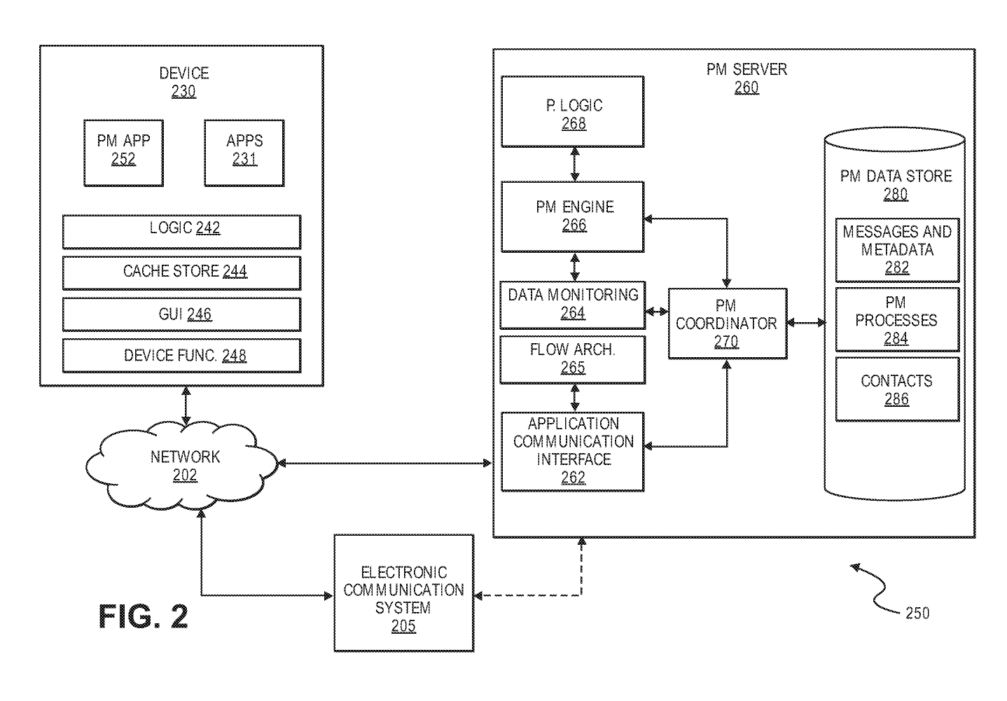

FIG. 2 is a block diagram of a system 250 in which a device 230 is in communication with a progress management server 260 in accordance with one embodiment. Progress management application 252 and a progress management server 260 provide additional details for the progress management applications and a progress management server discussed above in FIG. 1.

In one embodiment, the device 230 includes progress management application 252 and other applications 231. The device 230 (e.g., processing device, source device, client device, mobile device, tablet device, lap top, computer, etc) initiates a software application. For example, a user may select one of the software applications installed on the device. The device 230 includes logic 242 (e.g., communication logic for communications), a cache store 244 for storing data, messages, etc., a graphical user interface module 246 for generating graphical user interfaces on a display of the device, and device functionality 248 for determining device and connection capabilities (e.g., type of connection (e.g., 4G LTE, 3G, WiFi, WiMax, etc.), bandwidth of connection, location of device, and type of device, etc). Progress management server 260 includes an application communication interface 262, a flow architecture 265 for creating private and public template flows, data monitoring module 264, progress management engine module 266, processing logic 268, progress management coordinator 270, and progress management data store 280. In one embodiment, the progress management application 252 or other applications 231 and a progress management server 260 communicate with each other over various networks and network configurations as discussed above in FIG. 1.

The graphical user interface module 246 is responsible for dynamically generating an interface for a user including any interfaces for the applications of the device 230. In embodiments discussed herein, the progress management application 252 or applications 231 may generate the application interface as a web page, a standalone application, or a mobile application, based upon the type of computing system upon which the application is executed. In one example, a progress management application 252 receives a user request to register with progress management server 260, and for the creation of a new progress management system. In one embodiment, the request includes user specification of a username and password to be associated with the progress management system, as well as login credentials for one or more electronic communication systems 205. In another example, upon initiation of a third party service application 231, a user provides authentication information for access to the third party service application with a hosted web page that also includes features and functionality of the progress management server for managing processes (e.g., customer management, onboarding process for employees, business development, etc.) for an organization of the user. In this example, the user does not need to have a separate account with the PM application or server.

The logic 242 includes a communication interface for transmitting communications (e.g., requests, usernames, and authentication credentials, etc.) to the application communication interface 262 of the progress management server 260. In one embodiment, the communication interface and application communication interface 262 communicate with one another using standard communications protocols, such as HTTP, HTTPS, etc. Additionally, the data exchanged between the communication interface and application communication interface 262 may be exchanged as a single message, or a series of messages.

Application communication interface 262 provides the request, the user access credentials and the progress management username/password combination to progress management coordinator 270. Progress management coordinator 270 provisions storage space within progress management data store 280 for the new progress management system to be created for the user.

Progress management coordinator 270 further provides the user's authentication credentials for the various electronic communications systems to data monitoring module 264. The data monitoring module 264 utilizes the user's authentication credentials to access the electronic communication systems 205 via network 202 or locally (as indicated by dashed line). Initially, data monitoring module 264 obtains all, or at least a portion, of the user's past communication activities on each of the electronic communication systems 205. These communications are provided to progress management module 266 to analyze the electronic communications. The processing logic 268 can execute instructions for software of the PM server 260 include the module 266.

Progress management module 266 provides the results to progress management coordinator 270 for storage in a contacts/relationships database 286 in progress management data store 280. In one embodiment, when data monitoring module 264 passes the obtained electronic communications to progress management module 266, the electronic communications are also passed to progress management coordinator 270 for storage in a database 282 in progress management data store 280.

In one embodiment, progress management module 266 further determines one or more processes to associate with the user based on the user's communications. As discussed herein, the communications may indicate that the user engages in a sales process with a first group of users, engages in a recruiting process with a second group of users, etc. The progress management coordinator 270 stores these determined processes, and the additional user contacts associated with these processes in database 284 and 286.

In the embodiments discussed herein, the data displayed by graphical user interface module 246 can be configured for display based on characteristics of a device, such as screen size, resolution, dimensions, etc. Furthermore, the display may graphically illustrate a process, communications within the process, and a filtered result of the communications (e.g., display indicating an appropriate stage within a process).

In one embodiment, processes may be multi-user processes within an organization. In this embodiment, contacts, relationships, messages, suggestions, etc. may be accessible to other participants in a process (i.e., other sales people in an organization, specific users participating in a recruitment process, etc.). In one embodiment, progress management module 266 may further refine or add to contact details by leveraging contact data extracted from several users and several different communication services. Similarly, suggestions may be culled from one user's communications within a process, and the suggestion propagated to additional users.

The functionality of the progress management system can be implemented in a server system (e.g., PM server 110, PM server 260), or in each client device (e.g., devices 140, 130-1-130-N, 230) or it may be distributed between the server(s) and the client devices. Within a given device, the features and functionality can be implemented by one or more microprocessors executing computer program code stored in a memory and accessing data stored in a memory. The functionality of the progress management system or any client device can be physically implemented in a single physical enclosure or distributed among multiple physical enclosures, which may be connected via a network.

Network 102 or 202 represents any one or more of various types of networks, which may be wired or wireless or a combination thereof. The network may include, for example, a personal area network (PAN), local area network (LAN), wide area network (WAN), metropolitan area networks (MAN), global internetwork such as the Internet, cellular telecommunications network, etc.

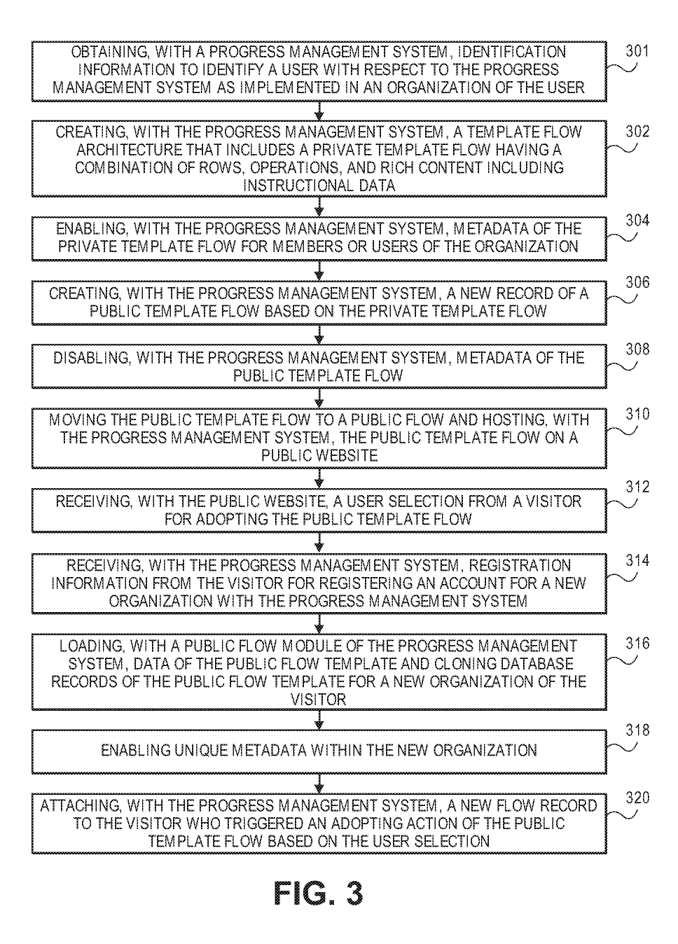

FIG. 3 illustrates a flow diagram of operations for a progress management system for providing private and public templates for business processes in accordance with one embodiment. The operational flow of the progress management system may be executed by an apparatus or system, which includes processing circuitry or processing logic. The processing logic may include hardware (circuitry, dedicated logic, etc.), software (such as is run on a general purpose computer system or a dedicated machine or a device), or a combination of both. In one embodiment, a system performs the operations of method 300 by executing instructions of any tools or modules of computing devices or servers (e.g., the PM server 110, PM server 260). The progress management system communicates with devices of users, electronic communication systems, and third party services via a network (e.g., network 102, 202). A user's device includes a web browser. An encrypted cookie on the user's web browser includes sufficient information to identify the user against a progress management system that is integrated with a discrete organization having a plurality of users. Typically, an origin server sends state information (e.g., encrypted cookie) to a user's device and the user's device returns state information to the origin server. To store state, the origin server includes a Set-Cookie header in an HTTP response. In subsequent requests, the user's device returns a Cookie request header to the origin server. The Cookie header contains cookies that the user's device received in previous Set-Cookie headers.

At operation 301, the progress management system (e.g., a collaborative network-based graphical progress management platform) obtains identification information (e.g., encrypted cookie) to identify a user (e.g., user's device) with respect to the progress management system as implemented in an organization of the user. For example, the organization may have an account established with the progress management system.

At operation 302, the user (e.g., author) of the organization creates a template flow architecture having a combination of rows, operations (steps), and rich content including instructional data using the progress management system (e.g., private flow module). The template flow architecture includes a private template flow that is private within the organization. At operation 304, metadata of the private template flow is enabled with the progress management system for members or users of the organization. Metadata may include integration signals, assigned teammates, data related to flow views across a team, completion progress, and timestamped comments. At operation 306, the user (e.g., author), using the progress management system, creates a new record of a public template flow based on the private template flow. The private template flow is flagged as being public within a user interface.

At operation 308, metadata of the public template flow is disabled with the progress management system. At operation 310, the progress management system moves the public template flow to a public flow and the public template flow is hosted on a public website (e.g., landing page). The public flow includes a category or type of public flow, a title, a cover image, and a description. The public flow also includes author information including an image for the author, a profile web page, and a description of the author.

At operation 312, upon a visitor visiting the public website having the public template flow, the progress management system receives a user selection from the visitor for adopting the public template flow (adopting action). At operation 314, the progress management system receives registration information from the visitor for registering an account for a new organization with the progress management system. At operation 316, the progress management system (e.g., public flow module) loads data of the public flow template in real time (e.g., less than 5 seconds, less than 2 seconds, less than 1 second) and proceeds to clone database records of the public flow template for the new organization in real time in response to the adopting action. At operation 318, unique metadata is enabled within the new organization. At operation 320, the progress management system (e.g., public flow module) attaches a new flow record to the visitor who triggered an adopting action of the public template flow. In one example, the original public template and the new flow record are mutually exclusive, excluding integrations (e.g., files stored in the cloud) pulled from a shared location. The operations 316, 318, 320 may occur in real time in response to the adopting action.

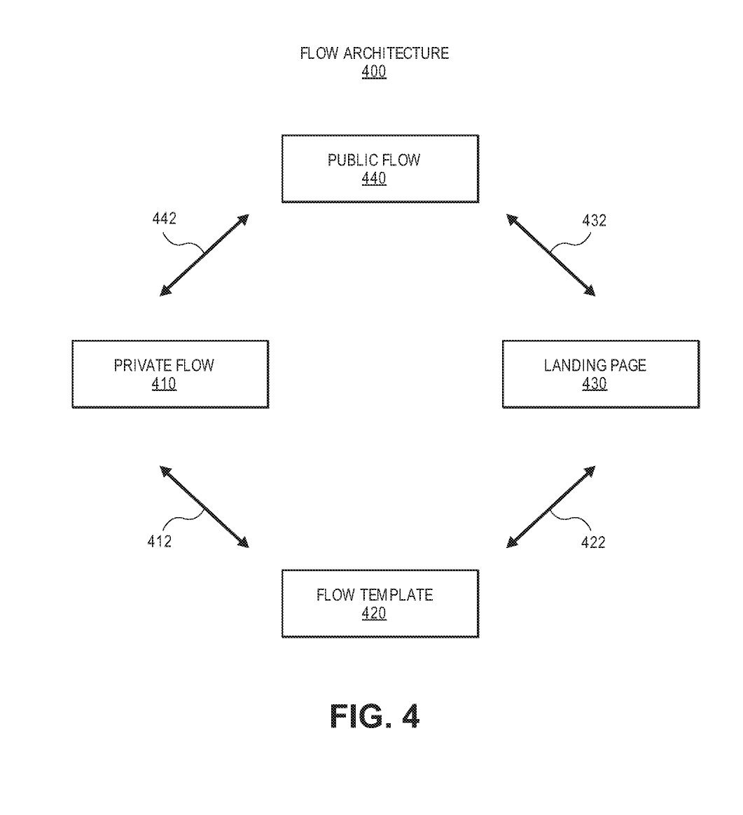

FIG. 4 illustrates a block diagram of a flow architecture of a progress management system for providing private and public templates for business processes in accordance with one embodiment. The operational flow (e.g., method 300) of the progress management system may be executed by an apparatus or system, which includes processing circuitry or processing logic. The processing logic may include hardware (circuitry, dedicated logic, etc.), software (such as is run on a general purpose computer system or a dedicated machine or a device), or a combination of both.

The progress management system (e.g., a collaborative network-based graphical progress management platform) obtains identification information (e.g., encrypted cookie) to identify a user (e.g., user's device) with respect to the progress management system as implemented in an organization of the user. For example, the organization may have an account established with the progress management system. The flow architecture 400 includes private flow module 410, flow template module 420, landing page module 430, and public flow module 440 for implementing private flows, creating public flows, and adopting public flows that can be made private within an organization. A flow proceeds from a first module to a second module or vice versa using operations 412, 422, 432, and 442.

The user (e.g., author) of the organization utilizes a private flow module 410 to create a template flow architecture having a combination of rows, steps, and rich content including instructional data. The private flow module 410 includes a private template flow that is private within the organization. Metadata of the private template flow is enabled with the progress management system for members or users of the organization. Metadata may include integration signals, assigned teammates, data related to flow views across a team, completion progress, and timestamped comments. The author, with operation 412, executes a private flow in transitioning from private flow module 410 to flow template module 420 and creates a new record of a public template flow based on the private template flow. The private template flow is flagged as being public within a user interface. Metadata of the public template flow is disabled with the flow template module 420.

At operation 422, the flow transitions from the flow template module 420 to the landing page module 430. The flow architecture moves the public template flow to a public flow and the public template flow is hosted on a public website (e.g., landing page 430). The public flow includes a category or type of public flow, a title, a cover image, and a description. The public flow also includes author information including an image for the author, a profile web page, and a description of the author.

At operation 432, upon a visitor visiting the public website having the public template flow, the landing page module 430 receives a user selection from the visitor for adopting the public template flow (adopting action). The progress management system receives registration information from the visitor for registering an account for a new organization with the progress management system. Next, the public flow module 440 loads data of the public flow template in real time and proceeds to clone database records of the public flow template for the new organization in real time. Unique metadata is enabled within the new organization. The public flow module 440 attaches a new flow record to the visitor who triggered an adopting action of the public template flow. The operations performed subsequent to the adopting action may occur in real time in response to the adopting action.

At operation 442, the user executes the public template flow and can make this flow private using private flow module 410.

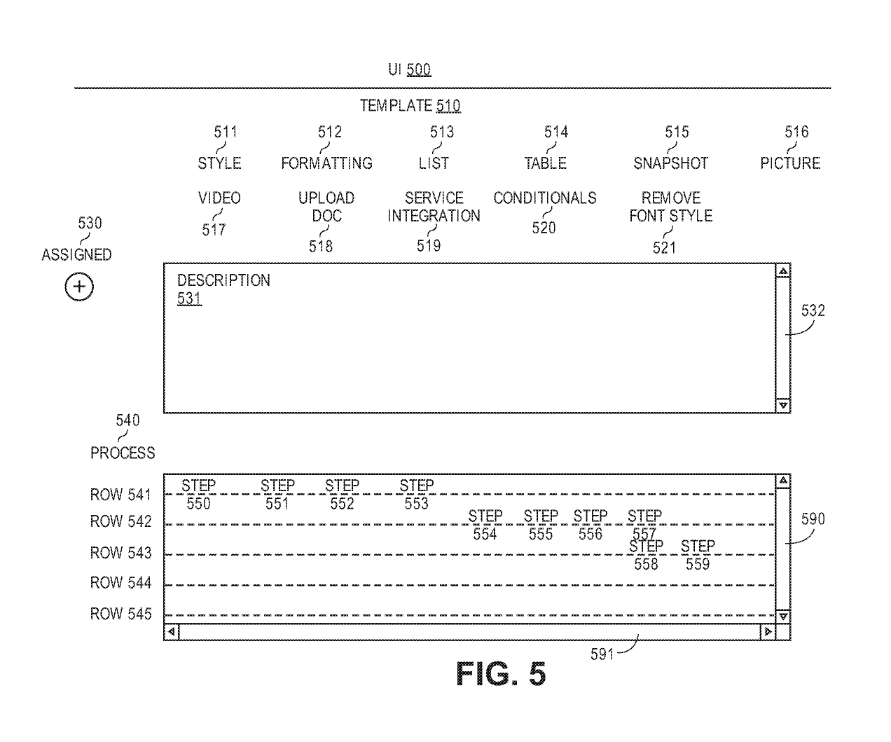

FIG. 5 illustrates an example of a flow template presented by the progress management system in accordance with one embodiment. A user (e.g., author) of an organization creates a template flow architecture having a combination of rows, steps, and rich content including instructional data using the progress management system (e.g., private flow module). The template flow architecture includes a private template flow that is private within the organization. Metadata of the private template flow is enabled with the progress management system for members or users of the organization. In one example, the user interface 500 includes a template region 510 (e.g., employee onboarding template, employee offboarding template, etc.) and a process region 540 that graphically displays operations (steps) and rows for what is accomplished at each stage in a process. The progress management system provides updates for operations and work actions (e.g., view, completion status, work from integrated service, assignment) in real time to user interfaces of the template flow architecture upon receiving any type of update of an operation or work action.

The template region 510 includes different selectable functions including style 511, formatting 512, list options 513, table 514, snapshot option 515 for capturing a screen shot of a web site, picture option 516, record video option 517, upload documents 518, service integration option 519 for connecting with third party services (e.g., monitoring resources of users having accounts with third party services), conditionals 520 (e.g., if answer is yes, go to select step a, if answer is no, go to select step b) for the process flow, and remove font style 521. A description region 531 can include a description of the template (e.g., job offer letter), research in regards to the template, and a sample template (e.g., a sample job offer letter). A cursor region 532 allows the description region 531 to be scrolled. An assigned option 530 allows one or more users or teammates to be assigned to this template flow.

The process region 540 includes rows 541-545, operations (steps) 550-559, and cursors regions 590 and 591 for scrolling this region. Each step can be labeled with what is accomplished at each stage in the process. Steps are grouped by function, stage, or subprocesses using rows. For example, row 541 (e.g., decision is made on potential new hire) can include step 550 (e.g., create job offer letter), step 551 (e.g., call potential new hire), step 552 (e.g., send out new hire email), and step 553 (e.g., email company or team). Row 542 (e.g., prep work: employee socialization) can include step 554 (e.g., find and select mentor), step 555 (e.g., meet with mentor), step 556 (e.g., arrange lunch date with . . . ), and step 557 (e.g., buddy email's new hire).

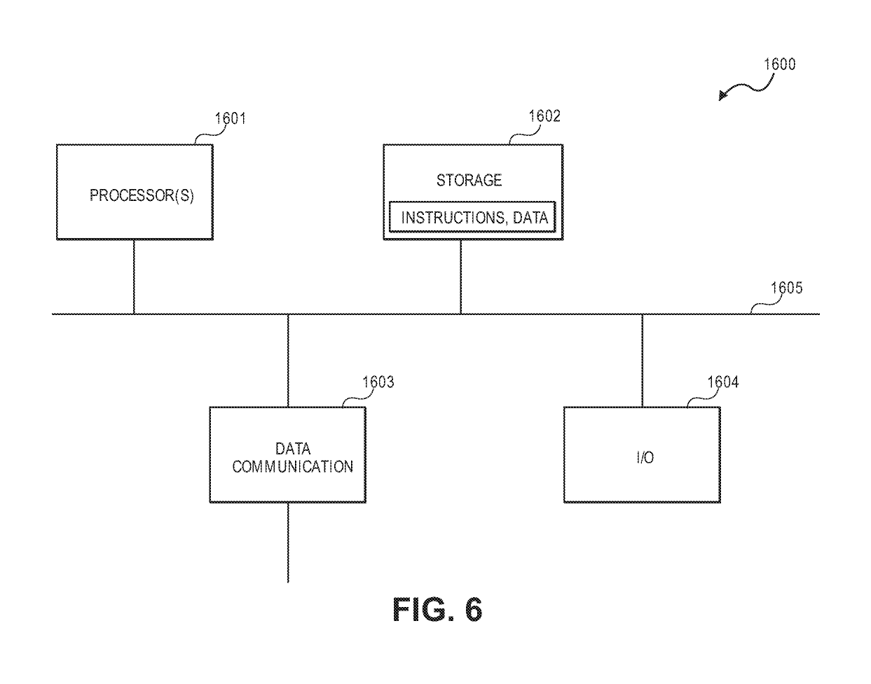

FIG. 6 shows an example, at a high level, of the internal architecture of a processing system 1600 representing any of the devices mentioned above, e.g., the PM server or any of the client devices in one embodiment. In the illustrated embodiment, the processing system 1600 includes one or more processors 1601, one or more data storage devices 1602, a data communication device 1603, and one or more input output (I/O) devices 1604. These components are connected to each other, either directly or indirectly, through an interconnect system 1605, which can include any one or more of various types of connections, including one or more point-to-point connections, buses, adapters, etc.

The processor(s) 1601 control the operation of the processing system 1600. Each processor 1601 can be or include a programmable microprocessor, microcontroller, application specific integrated circuit (ASIC), programmable logic device (PLD), or the like, or combination thereof. Each processor 1601 can execute instructions and/or operate upon data stored in storage device(s) 1602. Each storage device 1602 (e.g., machine-accessible non-transitory medium) can include any of various forms of storage, including random access memory (RAM), read-only memory (ROM), flash memory, hard disk drive, digital versatile disk (DVD) drive, removable storage such as one or more USB drives, or the like, or combination thereof.

In one example, a storage medium (e.g., a machine-accessible non-transitory medium) contains executable computer program instructions which when executed by processor(s) cause the system to perform any of the methods discussed herein. While the machine-accessible non-transitory medium 1602 is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present invention. The term “machine-accessible non-transitory medium” shall accordingly be taken to include, but not be limited to, solid-state memories, optical and magnetic media.

Data communication device 1603 enables the processing system 1603 to communication with other processing systems over a network, such as interconnect 1503 in FIG. 15. Data communication device 1603 may be or include, for example, a convention cable modem, digital subscriber line (DSL) modem, Ethernet adapter, wireless transceiver, or the like.

In one embodiment, software for providing the client-side functionality can be coded in JavaScript. In such an embodiment, software for implementing the server-side functionality may be coded in, for example, Objective-C, Java, or a combination thereof.

The server(s) may include one or more databases to store data, such as user account data, data input by users (e.g., data defining processprocesses, content associated with processes, settings, privileges), data defining the various user interface elements. Alternatively, at least some of that data can be stored, or at least cached, on one or more clients.

Data Dictionary

The following describes the various data entities that are used in one embodiment of the progress management system.

1. prog_template

This is a standard table with the base fields every table should have.

### Fields:

| Name | Type | Description | Comments |
|---|---|---|---|
| id | INT(11) | PK | |
| parameters | LONGTEXT | optional JSON configuration | nullable |
| | | object | |
| created | TIMESTAMP | the object's created date | |
| updated | TIMESTAMP | the object's date last modified | |
| created_by | INT(11) | FK to prog_user table | |
| updated_by | INT(11) | FK to prog_user table | |
| active | TINYINT(1) | BOOLEAN, is active? | |
| status | INT(11) | FK to status table | |

2. prog_users

This is a generic users table.

### Fields:

| Name | Type | Description | Comments |
|---|---|---|---|
| id | INT(11) | | |
| name | TEXT | | |
| username | TEXT | | |
| email | TEXT | | |
| password | TEXT | | |
| type | TEXT | | |
| block | TINY INT(1) | BOOLEAN | |
| send_email | TINY INT(1) | BOOLEAN | |
| register_date | DATETIME | | |
| last_visit_date | DATETIME | | |
| active | TINYINT(1) | BOOLEAN | |
| parameters | LONGTEXT | optional JSON | nullable |
| | | configuration object | |
| created | TIMESTAMP | | |
| updated | TIMESTAMP | | |
| status | INT(11) | | |
| created_by | INT(11) | FK to prog_user | |

3. prog_organizations

prog_organization defines a company of organization that many collaborators belong to.

### Fields:

| Name | Type | Description | Comments |
|---|---|---|---|
| id | INT(11) | PK | |
| name | TEXT | | |
| description | LONGTEXT | | nullable |
| size | TEXT | | nullable |
| industry | TEXT | | nullable |
| parameters | LONGTEXT | optional JSON configuration | nullable |
| | | object | |
| created | TIMESTAMP | the object's created date | |
| updated | TIMESTAMP | the object's date last modified | |
| created_by | INT(11) | FK to prog_user's | |
| updated_by | INT(11) | FK to prog_user table | |
| active | TINYINT(1) | BOOLEAN, is active? | |
| status | INT(11) | FK to status table | |

4. prog_addresses

This is represents a user or company address.

### Fields:

| Name | Type | Description | Comments |
|---|---|---|---|
| id | INT(11) | PK | |
| user_id | INT(11) | FK to prog_user table | nullable |
| organization_id | INT(11) | FK to prog_organization | nullable |
| | | table | |
| type | TEXT | | |
| address_1 | TEXT | | nullable |
| address_2 | TEXT | | nullable |
| address_3 | TEXT | | nullable |
| city | TEXT | | nullable |
| state | TEXT | | nullable |
| zip | TEXT | | nullable |
| phone | TEXT | | nullable |
| country | TEXT | | nullable |
| description | LONGTEXT | | nullable |
| name | TEXT | | nullable |
| parameters | LONGTEXT | optional JSON | nullable |
| | | configuration object | |
| created | TIMESTAMP | the object's created date | |
| updated | TIMESTAMP | the object's date last | |
| | | modified | |
| created_by | INT(11) | FK to prog_user's | |
| updated_by | INT(11) | FK to prog_user table | |
| active | TINYINT(1) | BOOLEAN, is active? | |
| status | INT(11) | FK to status table | |

5. prog_flows

prog_flow objects are at the top of the process hierarchy. All configuration data related to the entire process is contained within this table, along with the title, description, etc.

### Fields:

| Name | Type | Description | Comments |
|---|---|---|---|
| id | INT(11) | PK | |
| name | TEXT | | |
| description | LONGTEXT | | nullable |
| title | TEXT | | nullable |
| instructions | LONGTEXT | | nullable |
| allow_comments | TINYINT(1) | BOOLEAN | |
| allow_collaboration | TINYINT(1) | BOOLEAN | |
| parameters | LONGTEXT | optional JSON | nullable |
| | | configuration object | |
| created | TIMESTAMP | the object's created | |
| | | date | |
| updated | TIMESTAMP | the object's date last | |
| | | modified | |
| created_by | INT(11) | FK to prog_user's | |
| updated_by | INT(11) | FK to prog_user table | |
| active | TINYINT(1) | BOOLEAN, is active? | |
| status | INT(11) | FK to status table | |

6. prog_rows

prog_row objects represent the process's container for “steps”. Each row corresponds with a particular activity, department, or subject matter within a process. prog_row objects group prog_steps logically according to purpose or goal.

### Fields:

| Name | Type | Description | Comments |
|---|---|---|---|
| id | INT(11) | PK | |
| flow_id | INT(11) | FK to prog_flow table | |
| name | TEXT | | |
| description | LONGTEXT | | nullable |
| title | TEXT | | nullable |
| instructions | LONGTEXT | | nullable |
| allow_comments | TINYINT(1) | BOOLEAN | |
| allow_collaboration | TINYINT(1) | BOOLEAN | |
| position | INT(11) | sets the position of the | |
| | | step relative to other | |
| | | steps in a flow's row | |
| parameters | LONGTEXT | optional JSON | nullable |
| | | configuration object | |
| created | TIMESTAMP | the object's created | |
| | | date | |
| updated | TIMESTAMP | the object's date last | |
| | | modified | |
| created_by | INT(11) | FK to prog_user's | |
| updated_by | INT(11) | FK to prog_user table | |
| active | TINYINT(1) | BOOLEAN, is active? | |
| status | INT(11) | FK to status table | |

7. prog_steps

prog_step objects represent an individual “node” within a row around which content is created and collaborated on. Prog_steps represent the individual steps within a row that constitute a process.

### Fields:

| Name | Type | Description | Comments |
|---|---|---|---|
| id | INT(11) | PK | |
| flow_id | INT(11) | FK on prog_flow table | |
| row_id | INT(11) | FK to prog_row table | nullable |
| name | TEXT | | |
| description | LONGTEXT | | nullable |
| title | TEXT | | nullable |
| instructions | LONGTEXT | | nullable |
| estimated_time | FLOAT | | nullable |
| estimated_cost | FLOAT | | nullable |
| progress_by_date | DATETIME | | nullable |
| complete_by_date | DATETIME | | nullable |
| position | INT(11) | sets the position of the step relative | |
| | | to other steps in a flow's row | |
| allow_comments | TINYINT(1) | BOOLEAN | |
| allow_collaboration | TINYINT(1) | BOOLEAN | |
| parameters | LONGTEXT | optional JSON configuration | nullable |
| | | object | |
| created | TIMESTAMP | the object's created date | |
| updated | TIMESTAMP | the object's date last modified | |
| created_by | INT(11) | FK to prog_user's | |
| updated_by | INT(11) | FK to prog_user table | |
| active | TINYINT(1) | BOOLEAN, is active? | |
| status | INT(11) | FK to status table | |
| estimated_time_type | TEXT | | |
| estimated_cost_type | TEXT | | |
| explanation | LONGTEXT | | |

8. prog_contents

prog_content objects represent all content that can be associated at the flow, row, step, comment, and notes level. Content will be of the types defined in the prog_content_type table. All content items have a JSON object defined allowing for flexible configurations of content items.

### Fields:

| Name | Type | Description | Comments |
|---|---|---|---|
| id | INT(11) | PK | |
| type | INT(11) | FK to prog_content_type | |
| flow_id | INT(11) | FK on prog_flow | |
| parameters | LONGTEXT | stores a JSON object with | nullable |
| | | data relevant to content | |
| | | object | |
| content_binary | LONGBLOB | binary data | nullable |
| content_text | LONGTEXT | | nullable |
| created | TIMESTAMP | the object's created date | |
| updated | TIMESTAMP | the object's date last | |
| | | modified | |
| created_by | INT(11) | FK to prog_user's | |
| updated_by | INT(11) | FK to prog_user table | |
| active | TINYINT(1) | BOOLEAN, is active? | |
| status | INT(11) | FK to status table | |

9. prog_content_types

prog_content_type table is simply a list of values for all of the types of content that can be supported in the system.

The likely values of this table are: Video, Image, Map, Profile Page, Tweet, Weblink, URL, Source Document.

### Fields:

| Name | Type | Description | Comments |
|---|---|---|---|
| id | INT(11) | PK | |
| name | TEXT | | |
| description | LONGTEXT | | nullable |
| created | TIMESTAMP | the object's created date | |
| updated | TIMESTAMP | the object's date last modified | |
| created_by | INT(11) | FK to prog_user's | |
| updated_by | INT(11) | FK to prog_user table | |
| active | TINYINT(1) | BOOLEAN, is active? | |

10. prog_content_associations

This associates a piece of content with a flow, row, or step. The type of content and how it relates to its associated flow, row, or step is defined in the prog_content_association_type table.

### Fields:

| | | | Com- |
|---|---|---|---|
| Name | Type | Description | ments |
| id | INT(11) | PK | |
| type | INT(11) | FK on | not null |
| | | prog_content_association_type | |
| flow_id | INT(11) | FK on prog_flow | nullable |
| row_id | INT(11) | FK on prog_row | nullable |
| step_id | INT(11) | FK on prog_step | nullable |
| comment_id | INT(11) | FK to prog_comment | nullable |
| note_id | INT(11) | FK to prog_note | nullable |
| description | LONGTEXT | | nullable |
| content_id | INT(11) | FK to prog_content | |
| parameters | LONGTEXT | stores a JSON object with data | nullable |
| | | relevant to content object | |
| created | TIMESTAMP | the object's created date | |
| updated | TIMESTAMP | the object's date last modified | |
| created_by | INT(11) | FK to prog_user's | |
| updated_by | INT(11) | FK to prog_user table | |
| active | TINYINT(1) | BOOLEAN, is active? | |
| status | INT(11) | FK to status table | |

Unless contrary to physical possibility, it is envisioned that (i) the methods/operations described herein may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A computer implemented method comprising:
obtaining, with a progress management system, identification information to identify a user with respect to the progress management system as implemented in an organization of the user;
creating, with the progress management system, a template flow architecture that includes a private template flow having a combination of rows, operations, and rich content including instructional data;
enabling, with the progress management system, metadata of the private template flow for members or users of the organization; and
creating, with the progress management system, a new record of a public template flow based on the private template flow.

2. The computer implemented method of claim 1 comprising:
disabling, with the progress management system, metadata of the public template flow.

3. The computer implemented method of claim 1 comprising:
hosting, with the progress management system, the public template flow on a public website.

4. The computer implemented method of claim 1, wherein the public template flow includes a category or type of public flow, a title, a cover image, a description, and author information including an image for the author, a profile web page, and a description of the author.

5. The computer implemented method of claim 3 comprising:
receiving, with the public website, a user selection from a visitor for adopting the public template flow.

6. The computer implemented method of claim 5 comprising:
loading, with a public flow module of the progress management system, data of the public flow template; and
cloning database records of the public flow template for a new organization of the visitor.

7. The computer implemented method of claim 6 comprising:
enabling unique metadata within the new organization; and
attaching, with the progress management system, a new flow record to the visitor who triggered an adopting action of the public template flow based on the user selection.

8. The computer implement method of claim 1, wherein the metadata comprises integration signals, assigned teammates, data related to flow views across a team, completion progress, and timestamped comments.

9. A non-transitory machine-readable storage medium storing instructions that, when executed by a machine, cause the machine to perform a process that comprises:
obtaining, with a progress management system, identification information to identify a user with respect to the progress management system as implemented in an organization of the user;
creating, with the progress management system, a template flow architecture that includes a private template flow having a combination of rows, operations, and rich content including instructional data;
enabling, with the progress management system, metadata of the private template flow for members or users of the organization; and
creating, with the progress management system, a new record of a public template flow based on the private template flow.

10. The non-transitory machine-readable storage medium of claim 9 comprising:
disabling, with the progress management system, metadata of the public template flow.

11. The non-transitory machine-readable storage medium of claim 9 comprising:
hosting, with the progress management system, the public template flow on a public website.

12. The non-transitory machine-readable storage medium of claim 9, wherein the public template flow includes a category or type of public flow, a title, a cover image, a description, and author information including an image for the author, a profile web page, and a description of the author.

13. The non-transitory machine-readable storage medium of claim 11 comprising:
receiving, with the public website, a user selection from a visitor for adopting the public template flow.

14. The non-transitory machine-readable storage medium of claim 13 comprising:
loading, with a public flow module of the progress management system, data of the public flow template; and
cloning database records of the public flow template for a new organization of the visitor.

15. The non-transitory machine-readable storage medium of claim 14 comprising:
enabling unique metadata within the new organization; and
attaching, with the progress management system, a new flow record to the visitor who triggered an adopting action of the public template flow based on the user selection.

16. The non-transitory machine-readable storage medium of claim 9, wherein the metadata comprises integration signals, assigned teammates, data related to flow views across a team, completion progress, and timestamped comments.

17. A collaborative network-based graphical progress management system comprising:
a communications interface through which to communicate with a plurality of remote processing devices, each associated with a separate one of a plurality of users;
a memory; and
a processor coupled to the communications interface and the memory, the processor is configured to execute operations to obtain identification information to identify a user with respect to the progress management system as implemented in an organization of the user, to create a template flow architecture that includes a private template flow having a combination of rows, operations, and rich content including instructional data, to enable metadata of the private template flow for members or users of the organization, and to create a new record of a public template flow based on the private template flow.

18. The collaborative network-based graphical progress management system of claim 17, wherein the processor is configured to execute operations to disable metadata of the public template flow.

19. The collaborative network-based graphical progress management system of claim 17, wherein the processor is configured to execute operations to host the public template flow on a public website.

20. The collaborative network-based graphical progress management system of claim 17, wherein the public template flow includes a category or type of public flow, a title, a cover image, a description, and author information including an image for the author, a profile web page, and a description of the author.

21. The collaborative network-based graphical progress management system of claim 19, wherein the processor is configured to execute operations to receive a user selection from a visitor for adopting the public template flow.

22. The collaborative network-based graphical progress management system of claim 21, wherein the processor is configured to execute operations to load data of the public flow template and to clone database records of the public flow template for a new organization of the visitor.

23. The collaborative network-based graphical progress management system of claim 22, wherein the processor is configured to execute operations to enable unique metadata within the new organization and to attach a new flow record to the visitor who triggered an adopting action of the public template flow based on the user selection.

24. The collaborative network-based graphical progress management system of claim 17, wherein the metadata comprises integration signals, assigned teammates, data related to flow views across a team, completion progress, and timestamped comments.
